(19) United States
(12) Patent Application Publication
(10) Pub. No.: US 2013/0343596 A1
(43) Pub. Date: Dec. 26, 2013

(54) SPEAKER

(71) Applicant: Yu-Bin Zha, Shenzhen (CN)

(72) Inventor: Yu-Bin Zha, Shenzhen (CN)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/528,372

(22) Filed: Jun. 20, 2012

(51) Int. Cl. H04R 1/02

(52) U.S. Cl. 381/433

(57) ABSTRACT

Disclosed is a speaker having a magnet system. The magnet system includes an inner magnet and a yoke having an upper surface for fixing the inner magnet, a lower surface opposite to the upper surface, a sidewall connecting the upper and lower surfaces, and at least a concave extending from the upper surface towards the lower surface. The concave includes a bottom between the upper surface and the lower surface of the yoke.

### FIELD OF THE INVENTION

The present invention generally relates to the art of electro-acoustic transducers and, more particularly, to a speaker using in a portable consumer electronic device.

### DESCRIPTION OF RELATED ART

An electronic device, such as a cellular phone, a camcorder, a PDA, a digital camera, or a notebook computer, provides a space for accommodating a micro speaker therein. Nowadays, a speaker with high quality audio performance and miniature size is desired.

A related speaker comprises a holder, a magnet system received in the holder, a diaphragm supported by the holder, a voice coil attached to the diaphragm, and a cover pressing on a peripheral portion of the diaphragm. The magnet system includes a yoke, a magnet fixed on the yoke, and a magnetic gap formed between an inner surface of the yoke and an outer surface of the magnet for partially receiving the voice coil. The yoke defines a bottom portion for fixing the magnet and a plurality of sidewalls extending from the bottom portion.

In order to improve the performance of such a speaker, a through hole communicating outside with the magnetic gap to balance air pressure below the diaphragm during the vibration of the diaphragm is formed on the bottom portion of the yoke. The bottom portion of yoke comprises an upper surface and a lower surface opposite to the upper surface and the through hole is drilled from the upper surface completely through the lower surface. Such speaker may suffer from a large degree of flux leakage from the yoke, which weakens the performance of the speaker.

Therefore, it is desirable to provide an improved speaker which can overcome the above-mentioned problems.

### BRIEF DESCRIPTION OF THE DRAWINGS

FIG. 1 is an exploded view of a speaker in accordance with a first exemplary embodiment of the present invention.

FIG. 2 is an exploded view of a speaker in accordance with a second exemplary embodiment of the present invention.

Many aspects of the embodiments can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENTS

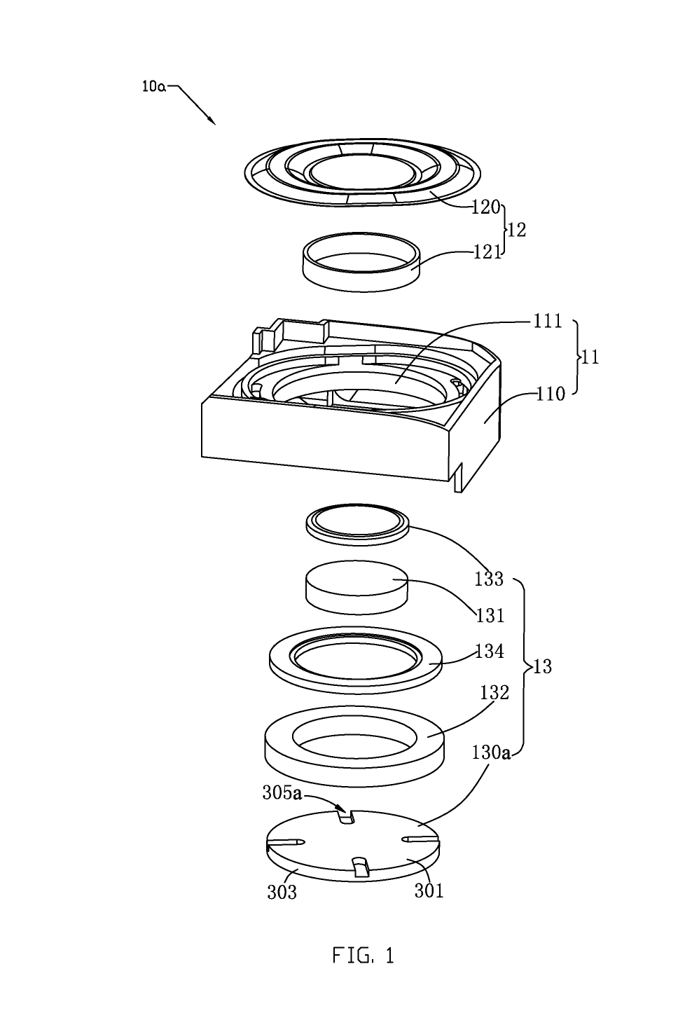

Reference will now be made to describe exemplary embodiments of the present disclosure in detail. Referring to FIG. 1, a speaker 10a comprises a holder 11, a magnet system 13 received in the holder 11, a diaphragm 120 supported by the holder 11, and a voice coil 121 driving the diaphragm 120 to vibrate. The magnet system 13 comprises a yoke 130a, an outer magnet 132 fixed on the yoke 130a, an inner magnet 131 attached on the yoke 130a and at least partially surrounded by the outer magnet 132, and a magnetic gap (no labeled) formed between an inner surface of the outer magnet 132 and an outer surface of the inner magnet 131 for partially receiving the voice coil 121. When alternating currents go through the voice coil, the magnet system will drive the voice coil to vibrate and the diaphragm will also be driven to vibrate by the voice coil accordingly, which converts the currents into sound waves.

The yoke 130a has a platy body and defines an upper surface 301 for fixing the inner and outer magnets 131, 132, a lower surface (no labeled) opposite to the upper surface 301, a sidewall 303 connecting the upper surface 301 and the lower surface, and at least a concave 305a extending from the upper surface 301 towards the lower surface. The concave 305a includes a bottom 305b located between the upper surface 301 and the lower surface, and an opening 305c formed in the sidewall 303. Furthermore, the concave 305a is arranged along the sidewall 303. In another words, the concave 305a radially extends from the sidewall 303 toward a center of the yoke 130a to balance an air pressure below the diaphragm 120 during the vibration of the diaphragm 120. In this embodiment, the yoke 130a has four concaves 305a. Each concave 305a is symmetrical and concentric with respect to the center of the yoke 130a for reducing a sound pressure below the diaphragm 120.

The diameter of the inner magnet 131 is smaller than that of the yoke 130a. When assembled, the inner magnet 131 is mounted on the upper surface 301 of the yoke 130a and the outer magnet 132 sets space with respect to the inner magnet 131 for forming the magnetic gap. The concave 305a is at least partially exposed from the inner surface of the outer magnet 132 and communicated with the magnetic gap. The inner magnet cooperates with the outer magnet for enhancing the sensitivity of the speaker.

The magnet system 13 further defines an inner pole plate 133 mounted on the inner magnet 131 and an outer pole plate 134 mounted on the outer magnet 132 and spaced apart from the inner pole plate 133. The yoke 130a and the pole plates 133, 134 are made of conductive materials for effectively conducting magnetic fluxes.

The holder 11 defines a lateral 110 and a hollow space 112 surrounded by the lateral 110 for receiving the magnet system. When assembled, an outer surface of the sidewall 303 of the yoke 130a together with an inner surface of the lateral 110 defines a clearance (no shown). An air below the diaphragm enters the concave 305a via the magnetic gap and finally leaks outside via the clearance, which balances the air pressure below the diaphragm.

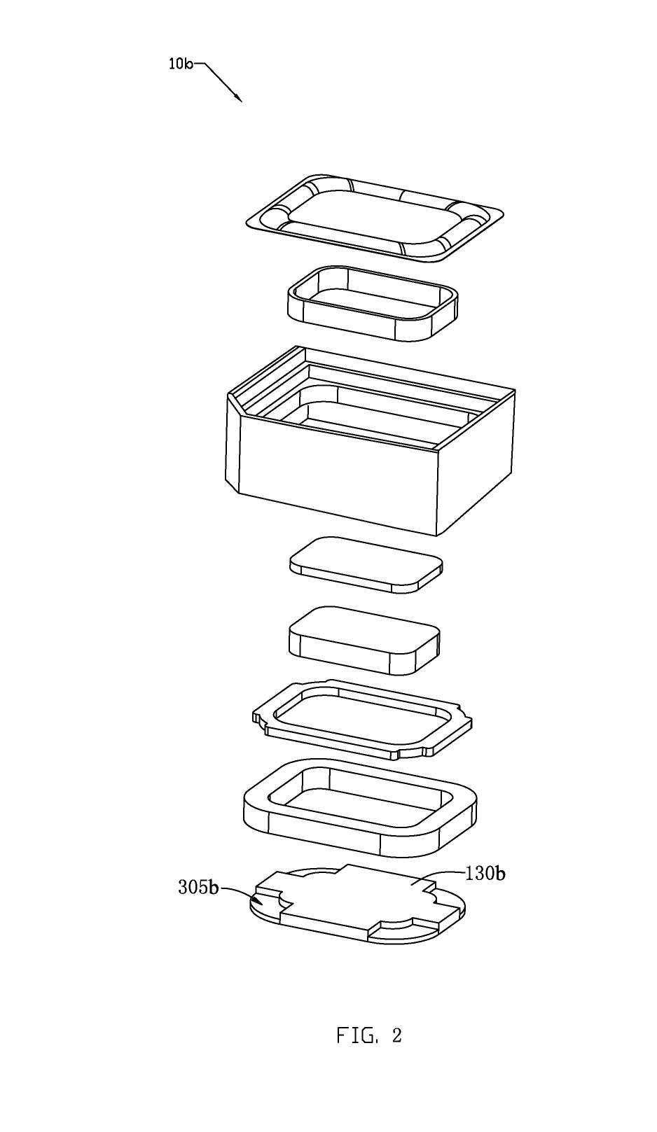

A second embodiment of the present invention is shown in FIG. 2. FIG. 2 shows a speaker 10b similar to the first embodiment of the present invention except that a yoke 130b is rectangular with rounded corners and the concave 305b is arranged on four corners of the yoke 130b.

In an alternative embodiment of the invention, an outer magnet can be omitted as long as the concave communicates the magnetic gap with the opening in the sidewall of the yoke.

The concave defines a bottom between the upper surface and the lower surface, which enables the yoke to support the magnet without magnetic flux leakage.

While the present disclosure has been described with reference to the specific embodiments, the description of the disclosure is illustrative and is not to be construed as limiting the disclosure. Various of modifications to the present disclosure can be made to the exemplary embodiments by those skilled in the art without departing from the true spirit and scope of the disclosure as defined by the appended claims.

What is claimed is:

1. A speaker, comprising:
an inner magnet;
a yoke having an upper surface for supporting the inner magnet, a lower surface opposite to the upper surface, a sidewall connecting the upper and lower surfaces, and at least a concave extending from the upper surface towards the lower surface;
a magnetic gap;
a voice coil partially received in the magnetic gap
wherein;
the concave includes a bottom between the upper surface and the lower surface, and an opening in the sidewall, and the concave communicates with the magnetic gap for balancing the air pressure in the magnetic gap and outside.

2. The speaker as described in claim 1 further including an outer magnet fixed on the upper surface of the yoke for forming the magnetic gap with the inner magnet.

3. The speaker as described in claim 1, wherein the yoke has four concaves symmetrical and concentric with respect to a center of the yoke.

4. The speaker as described in claim 1, wherein the yoke has a rectangular shape and the concave is arranged on the corner of the yoke.

5. A speaker, comprising:
a holder having a lateral and a hollow space surrounding the lateral;
a diaphragm mounted on the holder;
a magnet system received in the hollow space of the holder, the magnet system having an inner magnet and a yoke, the yoke having an upper surface for fixing the inner magnet, a lower surface opposite to the upper surface, a sidewall connecting the upper and lower surfaces, and at least a concave extending from the upper surface towards the lower surface;
a magnetic gap formed in the magnet system;
a clearance formed between the holder and the yoke for communicate;
wherein,
the concave includes a bottom between the upper surface and the lower surface, and an opening in the sidewall, and the concave communicates with the magnetic gap for balancing the air pressure in the magnetic gap and outside via the clearance.

6. The speaker as described in claim 5, wherein the magnet system further has an outer magnet fixed on the upper surface of the yoke and set space from the inner magnet for forming the magnetic gap.

7. The speaker as described in claim 5, wherein the yoke has four concaves symmetrical and concentric with respect to a center of the yoke.
The speaker as described in claim 5, wherein the yoke has a rectangular shaped and the concave is arranged on four corners of the yoke.

8. A speaker, comprising:
a yoke having a body including an upper surface, a lower surface, and a sidewall connecting the upper surface and the lower surface;
a magnet system supported by the yoke and forming a magnetic gap;
at least a concave formed in the body of the yoke, the concave including an upper opening in the upper surface of the yoke, a side opening in the sidewall of the yoke, and a bottom between the upper surface and the lower surface;
wherein
the upper opening is partially overlapped by the magnetic gap for communicating the magnetic gap with the side opening.
